(19) United States
(12) Patent Application Publication
(10) Pub. No.: US 2004/0056641 A1
(43) Pub. Date: Mar. 25, 2004

(54) Battery powered device including a battery terminal configured to receive an auxiliary power plug

(76) Inventors: Kenneth Myers, Marietta, GA (US); Drew Meincke, Woodstock, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/670,071

(22) Filed: Sep. 23, 2003

Related U.S. Application Data
(63) Continuation-in-part of application No. 10/173,566, filed on Jun. 18, 2002.

(51) Int. Cl. H02J 7/04

(52) U.S. Cl. 320/140; 503/215

(57) ABSTRACT

A battery powered device, such as a breast pump, that includes a battery terminal that is configured to also serve a receptacle for an auxiliary power cord. The battery powered device also includes a battery stop that allows a pin, which is configured to receive the auxiliary power cord, to also serve as a battery terminal. More specifically, the battery stop prevents a user from over-inserting the battery into the battery cavity and thereby breaking or bending the battery terminal, which is typically configured as a pin that also functions as a male receptacle for the auxiliary power cord. In this manner, the battery stop allows the same pin to serve as the battery terminal and as a male contact for the auxiliary power cord receptacle without exposing the pin to damage from over-insertion of the battery into the battery cavity.

### REFERENCE TO RELATED APPLICATION

This application is a continuation-in-part claiming priority to commonly-owned U.S. patent application Ser. No. 10/173,566 filed Jun. 19, 2002 and entitled “System for a Portable Hands-Free Breast Pump and Method for Using the Same.”

### TECHNICAL FIELD

The present invention relates to electric devices configured to receive power from batteries or an auxiliary power cord and, more particularly, relates to breast pump including a battery terminal configured to receive an auxiliary power plug.

### BACKGROUND OF THE INVENTION

Breast pumps for lactating mothers have been commercially available for many years. A major advance in breast pump technology occurred with the advent of a hands-free breast pump held between the mother's breast and her brazier. This type of breast pump typically runs on batteries so that the mother using the pump does not have to be tethered to an electricity outlet while using the pump. However, for those occasions when the batteries are run down or unavailable, it is advantageous for the pump to be powered by an auxiliary power cord that plugs into a standard wall outlet. This is particularly important for a breast pump because a nursing mother may need to pump at certain times to avoid a painful engorgement condition. For this reason, a back-up power source for the battery power is desirable for this type of device.

It should also be understood that breast pumps are consumer items offered for sale in a highly competitive market. For this reason, it is desirable to provide features, such as an auxiliary power supply, at minimum cost. Conventional devices configured to receive power from batteries or an auxiliary power supply have typically included an auxiliary power cord receptacle that is separate from the battery terminal. In addition, these devices typically require a voltage detector to determine whether auxiliary power is available through the auxiliary power cord so that the batteries can be disconnected from the device when auxiliary power is available. This configuration also includes a switch for disconnecting the batteries form the power circuit when auxiliary power is available. Although these components are relatively inexpensive, they can still add significantly to the overall cost of the device.

Accordingly, there is a need for a simple and cost effective way to integrate an auxiliary power supply into a battery powered device. There is a further need for a simple and cost effective auxiliary power supply for a battery powered breast pump.

### SUMMARY OF THE INVENTION

The present invention meets the needs described above in a battery powered device, such as a breast pump, that includes a battery terminal that is configured to also serve a receptacle for an auxiliary power cord. A particular embodiment of the battery powered device also includes a battery stop that allows a contact, which is configured to receive the auxiliary power cord, to also serve as a battery terminal. More specifically, the battery stop prevents a user from over-inserting the battery into the battery cavity and thereby breaking or bending the battery terminal, which is typically configured as a pin that also functions as a male receptacle for the auxiliary power cord. In this manner, the battery stop allows the same pin to serve as the battery terminal and as a male contact for the auxiliary power cord receptacle without exposing the pin to damage from over-insertion of the battery into the battery cavity.

It will therefore be appreciated that the present invention implements an auxiliary power receptacle within a battery terminal, which obviates the need for a redundant receptacle for the auxiliary power cord. This configuration inherently prevents the battery and the auxiliary power cord from being connected to the device at the same time. As a result, the device does not require a voltage detector to determine whether auxiliary power is available, nor does it require a switch to disconnect the battery from the power circuit when auxiliary power is available. For these reasons, the present invention is simpler and more cost effective than conventional approaches for incorporating an auxiliary power supply into a battery powered device.

The present invention may be implemented in any type of battery powered device, but is specifically designed as a improvement to a battery powered, hands-free breast pump. In this regard, the invention may be embodied within a battery powered device configured to receive an auxiliary power cord within a battery cavity of the device. Alternatively, the invention may be embodied as a battery powered device with an associated auxiliary power cord configured to be received within a battery cavity of the battery powered device. That is, the invention may be embodied in the battery powered device alone or in combination with an associated auxiliary power cord. In either embodiment, the battery powered device may include a battery stop to prevent the terminal that functions as a battery contact and as an auxiliary power cord contact from being damaged by over-insertion of the battery into the battery cavity.

Generally described, the invention may be implemented as a battery powered device provided with, or configured to work with, an associated auxiliary electric power cord. This auxiliary electric power cord is configured to supply electric power to the battery powered device between a first terminal and a second terminal of the battery powered device. The first terminal is positioned adjacent to a cavity in the battery powered device sized to receive a battery. The first terminal is configured to electrically contact an electrode of the battery when the battery is located within the cavity, and it is also configured to electrically contact a first lead of a plug of the auxiliary power cord when a housing of the plug is located within the cavity. The second terminal is configured to electrically contact a second lead of the plug when the housing of the plug is located within the cavity. The battery powered device may also include a battery stop located adjacent to the first terminal and configured to prevent the battery from damaging the first terminal through over-insertion of the battery into the cavity. For example, the battery stop may include a brow on a wall adjacent to the first terminal. In addition, the battery powered device may be configured to operate as a breast pump.

More specifically described, the invention may be implemented as a battery powered device provided with, or configured to work with, an associated auxiliary electric power cord. This auxiliary electric power cord is configured to supply electric power between a pin and a pickup of the battery powered device. The pin is positioned adjacent to a cavity in the battery powered device sized to receive a battery. The pin is configured to form a butt contact with an electrode of the battery when the battery is located within the cavity. The pin is also configured as a male contact to receive a female contact of the auxiliary power cord when a housing of the female contact is located within the cavity. The pickup is positioned adjacent to the pin and configured to electrically contact an outer surface of the female contact when the housing of the female contact is located within the cavity. The battery powered device may be configured to operate as a breast pump, and it may also include a battery stop located adjacent to the pin, such as a brow on a wall adjacent to the pin.

In view of the foregoing, it will be appreciated that the present invention provides a simple and cost effective way to incorporate an auxiliary power supply into a battery powered device. The specific techniques and structures for implementing the combined battery and auxiliary power cord terminal, and thereby accomplishing the advantages described above, will become apparent from the following detailed description of the embodiments and the appended drawings and claims.

### BRIEF DESCRIPTION OF THE DRAWINGS

FIG. 1 is a perspective view of the battery compartment of a breast pump with batteries installed.

FIG. 2 is perspective view of the battery compartment of the breast pump with the batteries removed.

FIG. 3 is a blow-up of the battery terminal of the breast pump, which also serves as an auxiliary power cord receptacle.

FIG. 4 is a perspective view of the battery compartment of the breast pump with an auxiliary power cord installed in a battery cavity.

FIG. 5 is a perspective view of the battery compartment of the breast pump with the auxiliary power cord installed and the battery cover installed.

FIG. 6 is a side view of an auxiliary power plug configured to be received in a battery cavity in a breast pump.

FIG. 7 is an end view of the auxiliary power plug of FIG. 6.

### DETAILED DESCRIPTION OF THE EMBODIMENTS

The present invention may be embodied in a combined battery and auxiliary power cord terminal in any type of battery powered device, but is specifically designed as a improvement to a battery powered, hands-free breast pump. The particular breast pump is described in commonly-owned U.S. patent application Ser. No. 10/173,566 filed Jun. 19, 2002 and entitled “System for a Portable Hands-Free Breast Pump and Method for Using the Same,” which is incorporated herein by reference. However, those skilled in the art will understand that the combined battery and auxiliary power cord terminal could just as well be implemented in any other type of battery powered device provided that the plug of the auxiliary power cord is properly shaped to fit the battery cavity of the device. As a result, those skilled in the art will understand how to modify the particular combined battery and auxiliary power cord terminal described below to work with different battery powered devices. Therefore, the invention is not limited to the particular breast pump embodiment described below and shown in the appended figures.

It should also be appreciated that the electric contacts of the combined battery and auxiliary power cord terminal are configured as a pin and leaf-type pickup located adjacent to the pin. In this configuration, the pin functions as a male receptacle to make electrical contact with a first lead of a female auxiliary power plug, while the pickup makes electrical contact with a second lead located on the outer surface of the of the female auxiliary power plug. However, two-lead configurations may be easily accommodated, such as two single-lead plugs, a two-socket female plug, or a plug that contacts both conventional battery terminals located on either end of a cylindrical battery (e.g., “AA” battery). In addition, a two-prong plug configured to fit in a conventional “D” battery cavity and connect with a standard “D” cell two-prong terminal may also be employed. Therefore, the pin and pickup terminal configuration of the preferred embodiment described below does not limit the invention to this particular arrangement. Nevertheless, it should also be appreciated that this particular pin and pickup terminal configuration is presently considered to be the most economically and technically sound implementation of the terminal configuration for a device powered by a conventional cylindrical battery.

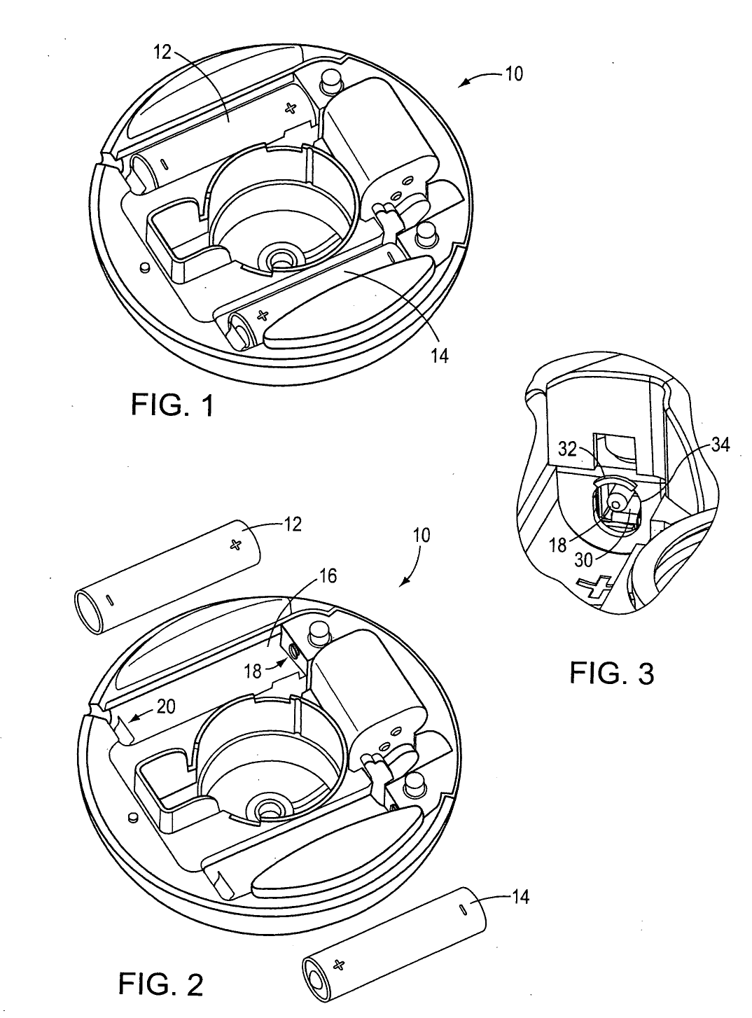

Turning now to the figures, in which like numerals refer to similar elements throughout the several figures, FIG. 1 is a perspective view of the battery compartment of a breast pump 10 with cylindrical batteries 12, 14 installed. In this particular illustration, the batteries are “AA” cells. FIG. 2 is perspective view of the battery compartment of the breast pump 10 with the batteries 12, 14 removed. Using the battery 12 for illustration purposes, this battery is removably received in a battery cavity 16 between two battery terminals 18, 20 in a conventional manner.

According to the present invention, the first battery terminals 18 also functions as a male receptacle for receiving a female plug 22 of an auxiliary power cord 24, as shown in FIG. 4. The auxiliary power cord 24 typically includes a power converter 26 that plugs into a conventional household AC (alternating current) outlet. The power converter 26 rectifies the A/C power received through a conventional household power outlet to an appropriate DC (alternating current) power supply for the breast pump 10, such as three Volts, as is well known to those skilled in the art of auxiliary power supplies for battery powered consumer items. The wire portion of the auxiliary power cord 24 passes through an opening 25 through the battery cavity 16, which serves as a wire chase. FIG. 5 shows the battery compartment of the breast pump with the auxiliary power cord 24 installed and the battery cover 28 installed.

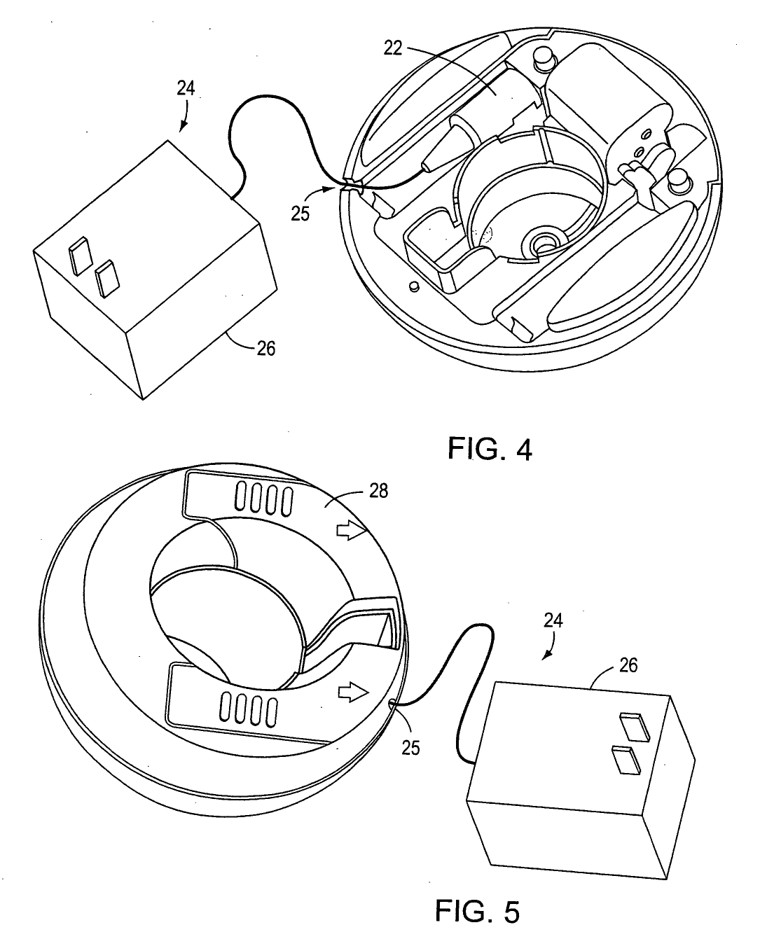

FIG. 3 is a blow-up of the battery terminal 18, which also serves as a male receptacle for the female plug 22 of the auxiliary power cord 24. To do so, the battery terminal 18 is configured as a pin in which the end of the pin functions as a butt contact with an electrode of the battery 12 while the post of the pin functions as a male receptacle for receiving the female plug 22 of the auxiliary power cord 24. The battery cavity 16 also defines an opening 34 adjacent to the pin-type battery terminal 18 configured to receive the female plug 22, which includes a connector that that fits through the opening 34 and over the pin-type battery terminal. In this manner, the opening 34 and the pin-type battery terminal 18 form a male receptacle for receiving a connector on the end of the female plug 22 of the auxiliary power cord 24.

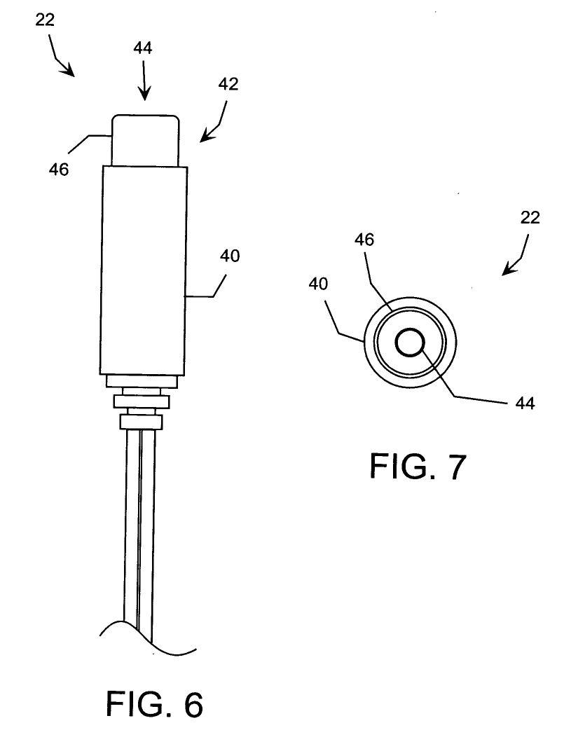

To complete an electric circuit, the breast pump 10 also includes a leaf-type pickup 30 positioned adjacent to, but not in electrical contact with, the pin-type battery terminal 18. The pin-type battery terminal 18 is configured to electrically contact a first lead of the auxiliary power cord 24 located on the interior of the female plug, while the pickup 30 is configured to electrically contact a second lead of the auxiliary power cord 24 located on the outer surface of the female plug, as shown in FIGS. 5 and 6, which are described below. The breast pump 10 also includes a battery stop, in this embodiment a brow 32 on the wall defining the opening 34 adjacent to the pin-type battery terminal 18, to prevent the pin from being bent or broken through over-insertion of the battery 12 into the battery cavity 16. Preventing this type of pin damage is important to keep the pin-type battery terminal 18 from being bent into electrical communication with the leaf-type pickup 30, which would short the power circuit of the breast pump 10.

Turning to the auxiliary power cord 24, FIG. 6 is a side view and FIG. 7 is an end view of a typical female plug 22 for this device. The plug 22 includes a housing 40 that is configured to be received within the battery cavity 16. A connector 42 extends from the housing 40 and is configured to function as a female receptacle that fits over the pin-type battery terminal 18. To do so, the housing 40 has a width that is greater than the opening 34 (shown in FIG. 3) through the battery cavity 16 adjacent to the pin-type battery terminal 18, while the connector 42 has a width configured to pass through the opening 34 so that the connector can be inserted over the pin. Specifically, the connector 42 includes a female socket 44 which serves as a first electrical lead that comes into electrical contact with the pin-type battery terminal 18. The connector 42 also includes a second lead 46, typically a conductive ring or outer surface, on the exterior of the connector that that comes into electrical contact with the leaf-type pickup 30.

In view of the foregoing, it will be appreciated that present invention provides a simple and cost effective way to incorporate an auxiliary power supply into a battery powered device. It should be understood that the foregoing relates only to the exemplary embodiments of the present invention, and that numerous changes may be made therein without departing from the spirit and scope of the invention as defined by the following claims.

The invention claimed is:

1. A battery powered device configured to receive auxiliary electric power applied between a first terminal and a second terminal; comprising:
the first terminal positioned adjacent to a cavity sized to receive a battery;
the first terminal configured to electrically contact an electrode of the battery when the battery is located within the cavity;
the first terminal also configured to electrically contact a first lead of an auxiliary power cord plug when a housing of the plug is located within the cavity;
the second terminal configured to electrically contact a second lead of the plug when the housing of the plug is located within the cavity.

2. The battery powered device of claim 1, configured to operate as a breast pump.

3. The battery powered device of claim 1, further comprising a battery stop located adjacent to the first terminal and configured to prevent the battery from damaging the first terminal through over-insertion of the battery into the cavity.

4. The battery powered device of claim 3, wherein the battery stop comprises a brow on a wall adjacent to the first terminal.

5. A battery powered device configured to receive auxiliary electric power applied between a pin and a pickup; comprising:
the pin positioned adjacent to a cavity sized to receive a battery;
the pin configured to form a butt contact with an electrode of the battery when the battery is located within the cavity;
the pin also configured as a male contact to receive a female contact of an auxiliary power cord when a housing of the female contact is located within the cavity;
the pickup positioned adjacent to the pin and configured to electrically contact an outer surface of the female contact when the housing of the female contact is located within the cavity.

6. The battery powered device of claim 5, further comprising a battery stop located adjacent to the pin and configured to prevent the battery from damaging the pin through over-insertion of the battery into the cavity.

7. The battery powered device of claim 6, wherein the battery stop comprises a brow on a wall adjacent to the pin.

8. The battery powered device of claim 7, configured to operate as a breast pump.

9. A battery powered device and an associated auxiliary electric power cord configured to supply auxiliary electric power between a first terminal and a second terminal of the battery powered device; comprising:
the first terminal positioned adjacent to a cavity in the battery powered device sized to receive a battery;
the first terminal configured to electrically contact an electrode of the battery when the battery is located within the cavity;
the first terminal also configured to electrically contact a first lead of a plug of the auxiliary power cord when a housing of the plug is located within the cavity;
the second terminal configured to electrically contact a second lead of the plug when the housing of the plug is located within the cavity.

10. The battery powered device of claim 9, wherein the battery powered device further comprises a battery stop located adjacent to the first terminal and configured to prevent the battery from damaging the first terminal through over-insertion of the battery into the cavity.

11. The battery powered device of claim 10, wherein the battery stop comprises a brow on a wall adjacent to the first terminal.

12. The battery powered device of claim 11, configured to operate as a breast pump.

13. A battery powered device and an associated auxiliary electric power cord configured to supply auxiliary electric power between a pin and a pickup of the battery powered device; comprising:
the pin positioned adjacent to a cavity in the battery powered device sized to receive a battery;
the pin configured to form a butt contact with an electrode of the battery when the battery is located within the cavity;
the pin also configured as a male contact to receive a female contact of the auxiliary power cord when a housing of the female contact is located within the cavity;
the pickup positioned adjacent to the pin and configured to electrically contact an outer surface of the female contact when the housing of the female contact is located within the cavity.

14. The battery powered device of claim 13, configured to operate as a breast pump.

15. The battery powered device of claim 14, further comprising a battery stop located adjacent to the pin and configured to prevent the battery from damaging the pin through over-insertion of the battery into the cavity.

16. The battery powered device of claim 15, wherein the battery stop comprises a brow on a wall adjacent to the pin.
